(19) United States
(12) Patent Application Publication
(10) Pub. No.: US 2021/0027395 A1
(43) Pub. Date: Jan. 28, 2021

(54) PET POSITIONING DEVICE AND ITS SOCIAL METHOD

(71) Applicants: Tao Sun, Beijing (CN); Qinghe Zhang, Beijing (CN)

(72) Inventors: Tao Sun, Beijing (CN); Qinghe Zhang, Beijing (CN)

(21) Appl. No.: 16/586,990

(22) Filed: Sep. 29, 2019

(30) Foreign Application Priority Data
Jul. 27, 2019 (CN) 201910685347.7

(51) Int. Cl. G06Q 50/00; H04W 4/029; A01K 15/02

(52) U.S. Cl. CPC G06Q 50/01; A01K 15/025; H04W 4/029

(57) ABSTRACT

The invention discloses a pet positioning device and its social method comprising a shell, hardware and a cooperative mobile control terminal wherein hardware includes a power module, a signal-receiving module, a central processor registration management module, and a GPS transmission module, a switch, and LED lights, among which the power module, signal-receiving module, central processor registration management module and GPS transmission module are inside the shell and interconnected through electric wires while switch and LED lights are on it; the power module provides power for pet locator; signal-receiving module receives signals from SIM card; central processor handles received signals, performs conversion calculation from signals to position information and, gives command to LED lights then corresponding LED light will be lit. Adopting the pet positioning device and its social method enables pet locator locate, measure distance, and know location of target, offering a more effective method for pets' social contact.

### BACKGROUND OF THE INVENTION

### 1. Field of the Invention

The invention relates to a positioning device, specifically relating to a pet positioning device and its social method.

### 2. Description of the Related Art

In this reinforced concrete forest in the city, an increasing number of people regard pets as their emotional sustenance and spend a great deal of time taking care of them. In this way, the scale of building social contact through taking care of pets becomes larger and larger. Furthermore, due to ever increasing pressure people in cities face, there is a tendency that people building social contact through pets become younger and younger. A larger quantity of social network sites and social APPs for pets exist all around the world, but current social network sites and social apps for pets are so limited in that they can't make people select pet social objects at any place and any time, which is difficult for introverts to build social contact; The location information provided by current RFID pet management mode is also limited in that, instead of locating position of pets accurately and receiving location information of other pets, it merely provides reference for the direction of pets for their users through signal strength, which makes it impossible to build straightforward and effective social contact. Therefore, it becomes a problem that demanding prompt solution to build a pet positioning system and its social method that can locate position of pets accurately, receive location information of other pets and build straightforward and effective social contact.

### SUMMARY OF THE INVENTION

The technical problems that the invention is to solve are that current technology's failure to make people select pet social objects at any place and any time, to locate position of pets accurately, and to receive location information of other pets, etc.

To overcome the technical problems above, the invention applies following technical plans: a pet positioning device and its social method comprises a shell, hardware and a cooperative mobile control terminal wherein said hardware includes a power module, a signal-receiving module, a central processor registration management module, and a GPS transmission module, a switch, and LED lights, among which the power module, the signal-receiving module, the central processor registration management module and the GPS transmission module are all set inside the shell and are interconnected through electric wires while the switch and the LED lights are set on the shell; the power module provides power for the pet locator; the signal-receiving module receives signals from SIM card; the central processor deals with received signals, performs conversion calculation from signals to location information and, at the same time, gives command to LED lights then corresponding LED light will be lit up.

Furthermore, social methods are as follows:

(1) Obtaining location information of surrounding pets that use the device;

(2) Guiding cellphone APP users to the target location of pets;

(3) After two pets using the device have a close contact or linger for designated time, APP users of both sides will be prompted to establish friendship.

(4) Once pets move outside the designated area, a warning will be sounded.

Furthermore, the model of said transmission module adopts the wireless communication module whose performance is equivalent to or better than that of CHEERZING MG2260 and, inside the transmission module, a SIM card is installed to communicate with the cloud server.

Furthermore, said LED light includes a device start-up reminder, a nighttime position reminder, and an alert after missing.

Furthermore, the model of said central processor registration management module uses CPU whose performance is equivalent to or better than that of Samsung S3C2443 ARM.

Furthermore, said shell adopts tag structure.

Compared with prior art, the invention has following merits: The invention employs the cooperative structure of signal-receiving module, the central processor registration management module, and the GPS transmission module that enables pet locator locate position, measure distance and know the position of the target accurately; It also has a mobile control terminal to cooperate with, thus providing a more straightforward approach for pet social contact; the invention is easy to operate and humanized in that it can be used only initiating the pet locator and finishing simple pairing are required; the invention is small in size and personalized in that it uses very small components which can be made into the tag without other designs, and the animal tag can meet users' needs and be made into customized and personalized products; the invention is low in cost because chips of hardware and software feature mass production, a combination of low cost and no extra charge for users when using.

### BRIEF DESCRIPTION OF THE DRAWINGS

FIG. 1 is a basic structural diagram of the pet positioning device and its social method.

FIG. 2 is a basic schematic view of the pet positioning device and its social method.

FIG. 3 is a flow chart of social relationship establishment for the pet positioning device and its social method.

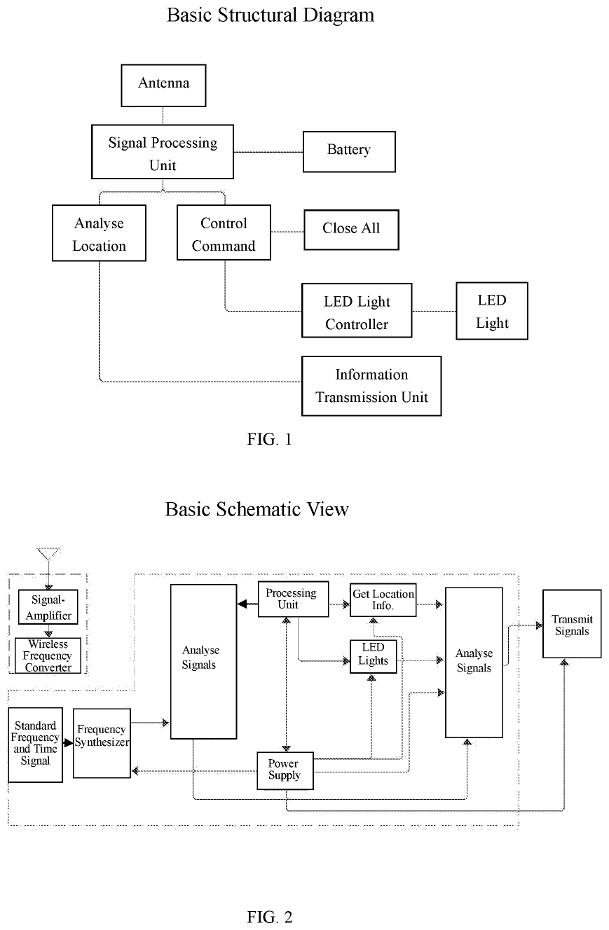

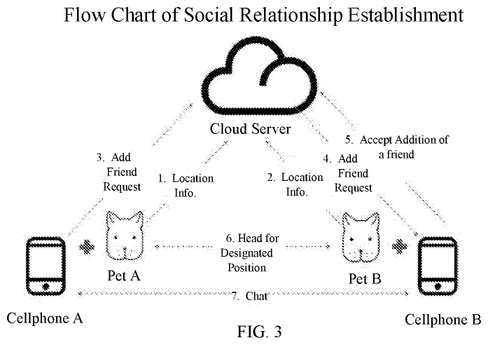

### DETAILED DESCRIPTION OF THE PREFERRED EMBODIMENTS

The invention is further described in detail hereinafter with reference to the drawings.

Combined with drawings, the invention will be described in detail.

In particular implementation, the invention provides a pet positioning device and its social method comprising a shell, hardware and a cooperative mobile control terminal wherein the hardware includes a power module, a signal-receiving module, a central processor registration management module, and a GPS transmission module, a switch, and LED lights, among which the power module, the signal-receiving module, the central processor registration management module and the GPS transmission module are all set inside the shell and are interconnected through electric wires while the switch and the LED lights are set on the shell; the power module provides power for the pet locator; the signal-receiving module receives signals from SIM card; the central processor deals with received signals, performs conversion calculation from signals to location information and, at the same time, gives command to LED lights then corresponding LED light will be lit up.

The implementing process and working principle are as follows: The implementing process is listed as follows: Firstly, turning on the switch, the pet locator will be started and begin to work by transmitting numbered location information to remote server regularly via the GPS transmission module. Then the remote server receives location information from pet locator and sends other surrounding pets' location and numbers to mobile control terminal. The mobile control terminal will mark real-time location of that in map interface. If both sides have established friendship, corresponding names will be shown according to pets' number. Users select the target pet to approach, then the mobile control recommends preferred walking solution to approach the target according to current location and changes recommended solution in accordance with shifted position of the target; when distance of two pet locators is less than the reference value, mobile control terminals of both sides' users will be prompted to establish friendship; the remote server will judge whether distance between initiated pet locator and mobile control terminal is within safe movement area according to pairing of the pet locator and mobile control terminal; if the distance is beyond safe movement area, users will be prompted through, but not limited to, prompt tone, vibration, indicator light, WeChat message, and text message, and the remote server will give command to the pet locator which is beyond safe movement area and prompt pet's location by changing luminance, color or other properties of LED light. The working principle: the signal-receiving module receives GPS signals which will be amplified via the signal-amplifier and be converted into standard frequency signals via wireless frequency converter; then the standard frequency and time signal transmits signals to frequency synthesizer to synthesize, transmits synthesized signals to central processor registration management module to analyse signals and, at the same time, receives location information and gives command to LED lights then corresponding LED light will be lit up; Next, analyzed signals will be sent to the remote server via the GPS transmission module; the invention employs the cooperative structure of signal-receiving module, the central processor registration management module, and the GPS transmission module that enables pet locator locate position, measure distance and know the position of the target accurately; It also has a mobile control terminal to cooperate with, thus providing a more straightforward approach for pet social contact; the invention is easy to operate and humanized in that it can be used only initiating the pet locator and finishing simple pairing are required; the invention is small in size and personalized in that it uses very small components which can be made into the tag or other similar device without other designs, and the animal tag can meet users' needs and be made into customized and personalized products; the invention is low in cost because chips of hardware and software feature mass production, a combination of low cost and no extra charge for users when using.

The invention and its embodiment have been described above, but the description is not limited thereto; the actual structure is not limited thereto. In general, it is to be understood by those skilled in the art that non-creative design of structural forms and embodiment that are similar to the technical solutions without departing from the spirit of the invention shall all fall within the protective scope of the invention.

1. A pet positioning device and its social method comprising a shell, hardware and a cooperative mobile control terminal wherein said hardware includes a power module, a signal-receiving module, a central processor registration management module, and a GPS transmission module, a switch, and LED lights, among which the power module, the signal-receiving module, the central processor registration management module and the GPS transmission module are all set inside the shell and are interconnected through electric wires while the switch and the LED lights are set on the shell, the power module providing power for the pet locator, the signal-receiving module receiving signals from SIM card, the central processor dealing with received signals, performing conversion calculation from signals to location information and, at the same time, giving command to LED lights then corresponding LED light will be lit up.

2. A pet positioning device and its social method of claim 1, wherein social methods are as follows:
(1) Obtaining location information of surrounding pets that use the device;
(2) Guiding cellphone APP users to the target location of pets;
(3) After two pets using the device have a close contact or linger for designated time, APP users of both sides will be prompted to establish friendship;
(4) Once pets move outside the designated area, a warning will be sounded.

3. A pet positioning device and its social method of claim 1, wherein said transmission module adopts the wireless communication module whose performance is equivalent to or better than that of CHEERZING MG2260 and, inside the transmission module, a SIM card is installed to communicate with the cloud server.

4. A pet positioning device and its social method of claim 1, wherein said LED light includes a device start-up reminder, a nighttime position reminder, and an alert after missing.

5. A pet positioning device and its social method of claim 1, wherein the model of said central processor registration management module uses CPU whose performance is equivalent to or better than that of Samsung S3C2443 ARM.

6. A pet positioning device and its social method of claim 1, wherein said shell adopts tag structure or structure similar to that.
